(19) United States
(12) Patent Application Publication
(10) Pub. No.: US 2019/0214695 A1
(43) Pub. Date: Jul. 11, 2019

(54) DEVICE TEMPERATURE CONTROLLER

(71) Applicant: DENSO CORPORATION, Kariya-city (JP)

(72) Inventors: Koji MIURA, Kariya-city (JP); Yasumitsu OMI, Kariya-city (JP); Takeshi YOSHINORI, Kariya-city (JP); Masayuki TAKEUCHI, Kariya-city (JP); Takashi YAMANAKA, Kariya-city (JP); Yoshiki KATO, Kariya-city (JP)

(21) Appl. No.: 16/351,738

(22) Filed: Mar. 13, 2019

Related U.S. Application Data
(63) Continuation of application No. PCT/JP2017/029122, filed on Aug. 10, 2017.

(30) Foreign Application Priority Data
Sep. 26, 2016 (JP) 2016-186951

(51) Int. Cl. H01M 10/6569; F28D 15/02; H01M 10/613; H01M 10/625; H01M 10/6556

(52) U.S. Cl. CPC H01M 10/6569; F28D 15/025; H01M 10/613; B60K 1/04; H01M 10/6556; H01M 2220/20; H01M 10/625

(57) ABSTRACT

A device temperature controller includes a heat absorber that absorbs heat from a temperature control target device to evaporate working fluid in liquid phase, and a condenser disposed above the heat absorber to condense the working fluid which has been evaporated into gas phase at the heat absorber. The device temperature controller includes a gas passage portion that guides the working fluid which has been evaporated into gas phase at the heat absorber to the condenser, and a liquid passage portion that guides the working fluid which has been condensed into liquid phase at the condenser to the heat absorber. At least a part of the gas passage portion and at least a part of the liquid passage portion are in contact with each other.

### CROSS REFERENCE TO RELATED APPLICATION

The present application is a continuation application of International Patent Application No. PCT/JP2017/029122 filed on Aug. 10, 2017, which designated the U.S. and claims the benefit of priority from Japanese Patent Application No. 2016-186951 filed on Sep. 26, 2016. The entire disclosures of all of the above applications are incorporated herein by reference.

### TECHNICAL FIELD

The present disclosure relates to a device temperature controller capable of controlling a temperature of at least one temperature control target device.

### BACKGROUND

A general battery temperature controller controls a battery temperature by using a loop-type thermosiphon system temperature controller. The battery temperature controller includes a heat medium cooling portion corresponding to a condenser for condensing a heat medium (i.e., working fluid), and a temperature control portion corresponding to a battery cooler.

The battery temperature controller includes an annular fluid circulation circuit formed by connecting the heat medium cooling portion and the temperature control portion via a liquid phase flow path which guides a liquid phase heat medium from the heat medium cooling portion to the temperature control portion, and a gas phase flow path which guides a gas phase heat medium from the temperature control portion to the heat medium cooling portion.

According to the battery temperature controller, the heat medium circulates between the heat medium cooling portion and the temperature control portion by a phase change of the heat medium between the liquid phase and the gas phase. In this manner, heat absorption from the battery continues at the temperature control portion of the battery temperature controller to cool the battery.

### SUMMARY

According to an aspect of the present disclosure, a device temperature controller includes: a heat absorber that absorbs heat from a temperature control target device to evaporate working fluid in liquid phase; a condenser disposed above the heat absorber to condense the working fluid which has been evaporated into gas phase at the heat absorber; a gas passage portion that guides the working fluid which has been evaporated into gas phase at the heat absorber to the condenser; and a liquid passage portion that guides the working fluid which has been condensed into liquid phase at the condenser to the heat absorber.

At least a part of the gas passage portion and at least a part of the liquid passage portion are in contact with each other.

According to another aspect of the present disclosure, a device temperature controller includes: a heat absorber that absorbs heat from a temperature control target device to evaporate working fluid in liquid phase; a condenser disposed above the heat absorber to condense the working fluid which has been evaporated into gas phase at the heat absorber; a gas passage portion that guides the working fluid which has been evaporated into gas phase at the heat absorber to the condenser; and a liquid passage portion that guides the working fluid which has been condensed into liquid phase at the condenser to the heat absorber.

At least a part of the gas passage portion and at least a part of the liquid passage portion constitute a double pipe structure in which the liquid passage portion is located inside the gas passage portion.

According to another aspect of the present disclosure, a device temperature controller includes: a heat absorber that absorbs heat from a temperature control target device to evaporate working fluid in liquid phase; a condenser disposed above the heat absorber to condense the working fluid which has been evaporated into gas phase at the heat absorber; a gas passage portion that guides the working fluid which has been evaporated into gas phase at the heat absorber to the condenser; and a liquid passage portion that guides the working fluid which has been condensed into liquid phase at the condenser to the heat absorber.

A cross-sectional area of at least a part of the liquid passage portion is smaller than a passage cross-sectional area of the gas passage portion.

### BRIEF DESCRIPTION OF THE DRAWINGS

FIG. 1 is a schematic configuration diagram of a device temperature controller according to a first embodiment.

FIG. 2 is a schematic diagram of the device temperature controller according to the first embodiment.

FIG. 3 is a schematic diagram showing a comparative example of the device temperature controller of the first embodiment.

FIG. 4 is a vertical cross-sectional view showing a state of working fluid in a gas passage portion of the comparative example of the first embodiment.

FIG. 5 is a vertical cross-sectional view showing a flow of working fluid in a liquid passage portion of the comparative example of the first embodiment.

FIG. 6 is a schematic cross-sectional view showing an internal structure of a portion VI in FIG. 1.

FIG. 7 is a cross-sectional view taken along a line VII-VII in FIG. 2.

FIG. 8 is a vertical cross-sectional view showing a flow of working fluid at a gas side contact portion and a liquid side contact portion in the first embodiment.

FIG. 9 is a Mollier diagram showing a state of working fluid circulating in a fluid circulation circuit.

FIG. 10 is a schematic cross-sectional view showing a modified example of the internal structure of the portion VI in FIG. 1.

FIG. 11 is a cross-sectional view showing a gas side contact portion and a liquid side contact portion in a second embodiment.

FIG. 12 is an explanatory diagram for explaining a dimensional relationship between a hydraulic diameter of the gas side contact portion and a hydraulic diameter of the liquid side contact portion.

FIG. 13 is a cross-sectional view showing a gas side contact portion and a liquid side contact portion in a third embodiment.

FIG. 14 is a cross-sectional view showing a modified example of the gas side contact portion and the liquid side contact portion in the third embodiment.

FIG. 15 is a cross-sectional view of a gas side contact portion and a liquid side contact portion in a fourth embodiment.

FIG. 16 is a cross-sectional view showing a modified example of the gas side contact portion and the liquid side contact portion in the fourth embodiment.

FIG. 17 is a cross-sectional view of a gas side contact portion and a liquid side contact portion in a fifth embodiment.

FIG. 18 is a cross-sectional view showing a modified example of the gas side contact portion and the liquid side contact portion in the fifth embodiment.

FIG. 19 is a cross-sectional view of a gas side contact portion and a liquid side contact portion in a sixth embodiment.

FIG. 20 is a cross-sectional view showing a first modified example of the gas side contact portion and the liquid side contact portion in the sixth embodiment.

FIG. 21 is a cross-sectional view showing a second modified example of the gas side contact portion and the liquid side contact portion in the sixth embodiment.

FIG. 22 is a cross-sectional view showing a third modified example of the gas side contact portion and the liquid side contact portion in the sixth embodiment.

FIG. 23 is a schematic diagram of a device temperature controller according to a seventh embodiment.

FIG. 24 is an explanatory diagram for explaining a liquid surface height of a gas passage portion and a liquid surface height of a liquid passage portion of the device temperature controller in the seventh embodiment.

FIG. 25 is an explanatory view for explaining a liquid surface height of a gas passage portion and a liquid surface height of a liquid passage portion in a comparative example of the device temperature controller in the seventh embodiment.

### EMBODIMENTS

Embodiments according to the present disclosure are hereinafter described with reference to the drawings. In any of the embodiments described herein, parts identical or equivalent to corresponding parts described in any of the preceding embodiments are given identical reference numerals, and description of the corresponding parts is not repeated in some cases. When only a part of constituent elements are described in any of the embodiments, the remaining part of the constituent elements described in any of the preceding embodiments is applicable. The respective embodiments described herein may be partially combined within a range not particularly causing problems even when not expressly presented.

### First Embodiment

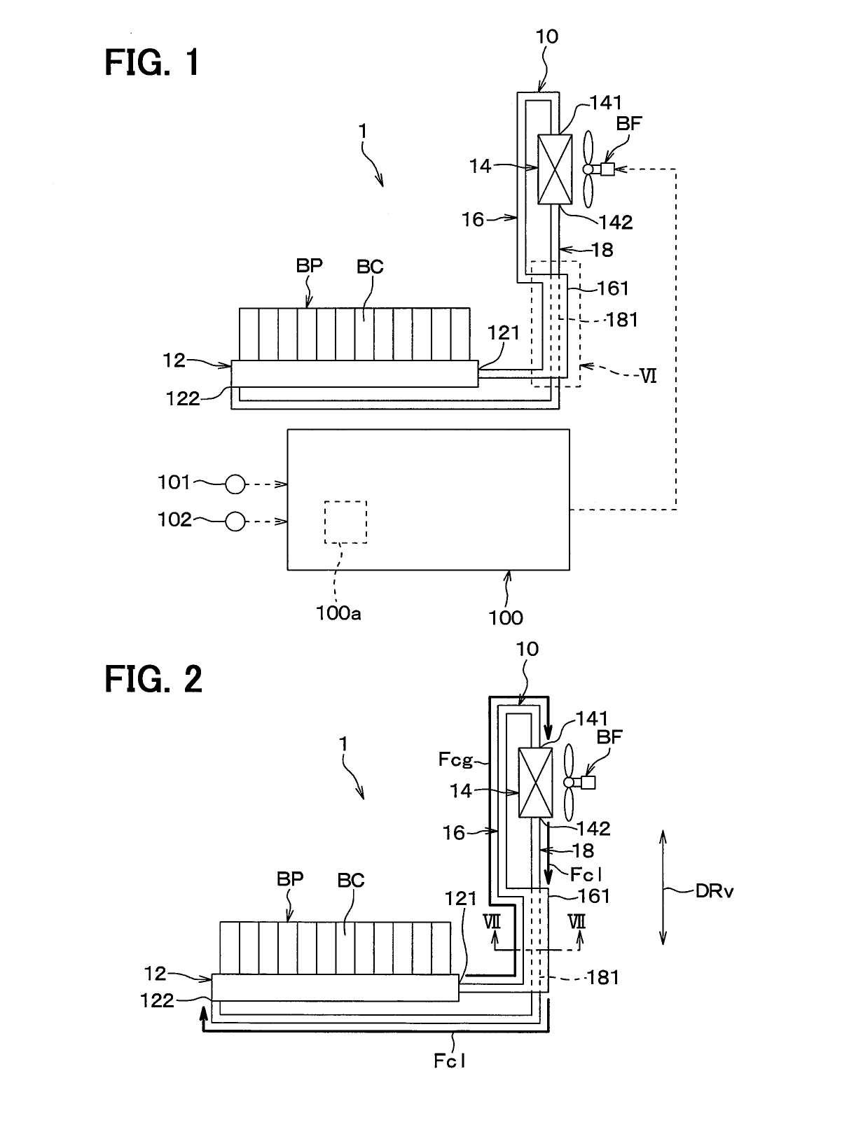

The present embodiment will be described with reference to FIGS. 1 to 9. In the present embodiment, a device temperature controller 1 of the present disclosure applied to a device for controlling a battery temperature Tb of a battery pack BP mounted on a vehicle will be described by way of example. It is assumed that the vehicle on which the device temperature controller 1 shown in FIG. 1 is mounted is an electric vehicle, a hybrid vehicle, or the like which travels by a not-shown traveling electric motor including the battery pack BP as a power source.

The battery pack BP is constituted by a laminate body including a plurality of laminated battery cells BC each having a rectangular parallelepiped shape. The plurality of battery cells BC constituting the battery pack BP are electrically connected in series. Each of the battery cells BC constituting the battery pack BP is a chargeable/dischargeable secondary battery (e.g., lithium ion battery, lead storage battery). Each shape of the battery cells BC is not limited to a rectangular parallelepiped shape, but may be other shapes such as a cylindrical shape. The battery pack BP may include the battery cells BC electrically connected in parallel.

The battery pack BP is connected to a not-shown power conversion device and a motor generator. For example, the power conversion device is a device which converts a direct current supplied from the battery pack BP into an alternating current, and supplies (i.e., discharges) the converted alternating current to various electric loads such as the traveling electric motor. The motor generator is a device which inversely converts traveling energy of the vehicle into electric energy at the time of regeneration of the vehicle, and supplies the inversely converted electric energy to the battery pack BP as regenerative electric power via the power conversion device or the like.

The temperature of the battery pack BP becomes extremely high in some cases by self-heating of the battery pack BP during power supply for traveling of the vehicle or on other occasions. Deterioration of the battery cells BC develops when the temperature of the battery pack BP becomes excessively high. It is therefore necessary to set limitation to output and input to reduce self-heating. Accordingly, for securing sufficient output and input of the battery cells BC, a cooling means for maintaining a predetermined temperature or lower is needed.

Moreover, the battery temperature Tb of the battery pack BP may become excessively high also during parking in the summertime, for example. Specifically, a power storage device including the battery pack BP is often disposed under a floor of the vehicle or below a trunk room. Accordingly, the battery temperature Tb of the battery pack BP gradually increases not only during traveling of the vehicle but also during parking in the summertime, for example. In this case, the temperature of the battery pack BP may become excessively high. When the battery pack BP is left in a high-temperature environment, deterioration develops to such a level that the life of the battery considerably shortens. It has been therefore demanded to maintain the battery temperature Tb of the battery pack BP at a predetermined temperature or lower even during parking of the vehicle, for example.

Moreover, the battery pack BP is constituted by a plurality of the battery cells BC. When the respective battery cells BC have different temperatures, deterioration of the respective battery cell BC develops in an unbalanced manner. In this case, input/output characteristics of the entire battery pack BP are lowered. More specifically, the battery pack BP includes a series connection body of the battery cells BC. The input/output characteristics of the entire battery pack BP are therefore determined by the battery characteristics of the battery cell BC most deteriorated in the respective battery cells BC. Accordingly, for achieving desired performance of the battery pack BP for a long period, temperature equalization which reduces temperature differences of the respective battery cells BC is essential.

The cooling means generally adopted for cooling the battery pack BP is an air cooling type cooling means using a blower, or a cooling means utilizing cold heat of a vapor compression type refrigeration cycle.

However, the air cooling type cooling means using the blower only feeds air or the like inside a vehicle to the battery pack BP. In this case, sufficient cooling capacity for cooling the battery pack BP may be difficult to obtain.

On the other hand, the cooling means utilizing cold heat of the refrigeration cycle produces a high cooling capacity for the battery pack BP. However, this cooling means requires driving of a compressor or the like which consumes a large volume of power during parking of the vehicle. In this case, undesirable conditions such as power consumption increase and noise increase may be caused.

Accordingly, the device temperature controller 1 of the present embodiment adopts a thermosyphon system which controls the battery temperature Tb of the battery pack BP by natural circulation of working fluid instead of forced circulation of a refrigerant by a compressor.

The device temperature controller 1 is a device which controls the battery temperature Tb of the battery pack BP mounted on a vehicle and corresponding to a temperature control target device. As shown in FIG. 1, the device temperature controller 1 includes a fluid circulation circuit 10 through which working fluid circulates, and a control device 100. Working fluid adopted herein as fluid circulating in the fluid circulation circuit 10 is a refrigerant (e.g., R134a, R1234yf) used in a vapor compression type refrigeration cycle.

The fluid circulation circuit 10 is a heat pipe which transfers heat through evaporation and condensation of working fluid, and constitutes a loop type thermosyphon where a flow path through which gaseous working fluid flows, and a flow path through which liquid working fluid flows are separated from each other.

As shown in FIG. 2, the fluid circulation circuit 10 includes a heat absorber 12, a condenser 14, a gas passage portion 16, and a liquid passage portion 18. An arrow DRv shown in FIG. 2 indicates an extending direction of a vertical line, i.e., a vertical direction.

The fluid circulation circuit 10 of the present embodiment connects the heat absorber 12, the condenser 14, the gas passage portion 16, and the liquid passage portion 18 to constitute a closed annular fluid circuit. A predetermined amount of working fluid is sealed into the fluid circulation circuit 10 in an evacuated state inside the fluid circulation circuit 10.

The heat absorber 12 is a heat exchanger functioning as an evaporator which absorbs heat from the battery pack BP and evaporates liquid working fluid by the absorbed heat during cooling of the battery pack BP corresponding to the temperature control target device. The heat absorber 12 is disposed at a position facing the bottom surface side of the battery pack BP. The heat absorber 12 has a thin flat rectangular parallelepiped shape.

A device proximity portion included in the heat absorber 12 and located close to the bottom surface portion of the battery pack BP constitutes a heat transfer portion for transferring heat between the battery pack BP and the heat absorber 12. The device proximity portion is so sized as to cover the whole area of the bottom surface portion of the battery pack BP to prevent generation of temperature distribution of the respective battery cells BC constituting the battery pack BP.

The device proximity portion of the heat absorber 12 contacts the bottom surface portion of the battery pack BP to transfer heat between the heat absorber 12 and the battery pack BP. The device proximity portion of the heat absorber 12 may be positioned away from the bottom surface portion of the battery pack BP as long as heat transfer is achievable between the device proximity portion and the battery pack BP.

When the liquid surface of the working fluid at the heat absorber 12 is located away from the device proximity portion of the heat absorber 12, heat transfer from the battery pack BP toward the liquid working fluid inside the heat absorber 12 is difficult to achieve. Specifically, when the liquid surface of the working fluid in the heat absorber 12 is located away from the device proximity portion of the heat absorber 12, evaporation of the liquid working fluid present inside the heat absorber 12 decreases.

According to the present embodiment, therefore, a filling amount of the working fluid sealed into the fluid circulation circuit 10 is set to an amount sufficient for filling the inside of the heat absorber 12 during cooling of the battery pack BP. The liquid surface of the working fluid of the present embodiment is formed in both the inside of the gas passage portion 16 and the inside of the liquid passage portion 18 at least at a stop of cooling of the battery pack BP. More specifically, at least at a stop of cooling of the battery pack BP, the liquid surface of the working fluid of the present embodiment is formed in both the inside of the gas passage portion 16 and the inside of the liquid passage portion 18, both of the portions 16 and 18 being located above the heat absorber 12.

The heat absorber 12 has a gas outlet 121 to which a lower end of the gas passage portion 16 is connected, and a liquid inlet 122 to which a lower end of the liquid passage portion 18 is connected. According to the present embodiment, the gas outlet 121 is provided in a side surface portion of the heat absorber 12, while the liquid inlet 122 is provided in a bottom surface portion of the heat absorber 12. The liquid inlet 122 may be provided in the side surface portion of the heat absorber 12 similarly to the gas outlet 121.

The heat absorber 12 is made of a metal or an alloy having excellent thermal conductivity, such as aluminum and copper. The heat absorber 12 may be made of a material other than metal. However, it is preferable that at least the device proximity portion constituting the heat transfer portion be made of a material having excellent thermal conductivity.

The condenser 14 is a heat exchanger for condensing gaseous working fluid evaporated at the heat absorber 12. The condenser 14 is constituted by an air-cooling type heat exchanger which achieves heat exchange between blown air fed from a blowing fan BF and the gaseous working fluid to condense the gaseous working fluid. The condenser 14 is disposed above the heat absorber 12 in the vertical direction DRv to move the liquid working fluid condensed inside the condenser 14 toward the heat absorber 12 by the own weight of the working fluid.

The condenser 14 has a gas inlet 141 to which an upper end of the gas passage portion 16 is connected, and a liquid outlet 142 to which an upper end of the liquid passage portion 18 is connected. According to the present embodiment, the gas inlet 141 and the liquid outlet 142 of the condenser 14 are provided at portions facing each other in the vertical direction.

In addition, the condenser 14 of the present embodiment is disposed such that the gas inlet 141 is located above the liquid outlet 142 in the vertical direction DRv. More specifically, the gas inlet 141 of the condenser 14 of the present embodiment is provided at an upper end of the condenser 14, while the liquid outlet 142 is provided at a lower end of the condenser 14.

The condenser 14 is made of a metal or an alloy having excellent thermal conductivity such as aluminum and copper. The condenser 14 may contain a material other than metal. However, it is preferable that at least a portion exchanging heat with air be made of a material having excellent thermal conductivity.

The blowing fan BF is a device which blows air inside the vehicle or air outside the vehicle toward the condenser 14. The blowing fan BF functions as a heat release amount controller which controls a heat release amount of working fluid present inside the condenser 14. The blowing fan BF is constituted by an electric fan which operates by energization. The blowing fan BF is connected to a control device 100. Blowing capability of the blowing fan BF is controlled on the basis of a control signal generated from the control device 100.

The gas passage portion 16 guides gaseous working fluid evaporated at the heat absorber 12 toward the condenser 14. A lower end of the gas passage portion 16 is connected to the gas outlet 121 of the heat absorber 12, while an upper end of the gas passage portion 16 is connected to the gas inlet 141 of the condenser 14. The gas passage portion 16 of the present embodiment is constituted by a pipe containing a flow path inside the pipe. The flow path is a path through which working fluid flows.

The gas passage portion 16 of the present embodiment is constituted by a cylindrical pipe having a circular passage cross section. The gas passage portion 16 shown in the figure is presented only by way of example. The gas passage portion 16 may be appropriately modified in consideration of the mountability on the vehicle.

The liquid passage portion 18 guides liquid working fluid condensed at the condenser 14 toward the heat absorber 12. A lower end of the liquid passage portion 18 is connected to the liquid inlet 122 of the heat absorber 12, while an upper end of the liquid passage portion 18 is connected to the liquid outlet 142 of the condenser 14. The liquid passage portion 18 of the present embodiment is constituted by a pipe containing a flow path inside the pipe. The flow path is a path through which working fluid flows. The liquid passage portion 18 of the present embodiment is constituted by a cylindrical pipe having a circular passage cross section.

A condenser 14 side portion of the liquid passage portion 18 of the present embodiment is located above a heat absorber 12 side portion of the liquid passage portion 18. The liquid passage portion 18 shown in the figure is presented only by way of example. The liquid passage portion 18 may be appropriately modified in consideration of the mountability on the vehicle.

According to the thermosiphon system device temperature controller 1 configured as described above, the liquid working fluid begins to evaporate at the heat absorber 12 when the temperature of the working fluid present on the condenser 14 side becomes lower than the battery temperature Tb of the battery pack BP. At this time, the battery pack BP is cooled by latent heat of evaporation of the liquid phase working fluid at the heat absorber 12.

The working fluid evaporated inside the heat absorber 12 is gasified, and flows into the condenser 14 via the gas passage portion 16. The gaseous working fluid having flowed into the condenser 14 is cooled and liquified by the condenser 14, and again flows into the heat absorber 12 via the liquid passage portion 18.

As described above, the device temperature controller 1 has a configuration in which the working fluid naturally circulates in the fluid circulation circuit 10 in an order of the heat absorber 12, the gas passage portion 16, the condenser 14, and the liquid passage portion 18 to be capable of achieving continuous cooling for the battery pack BP without requiring a driving device such as a compressor.

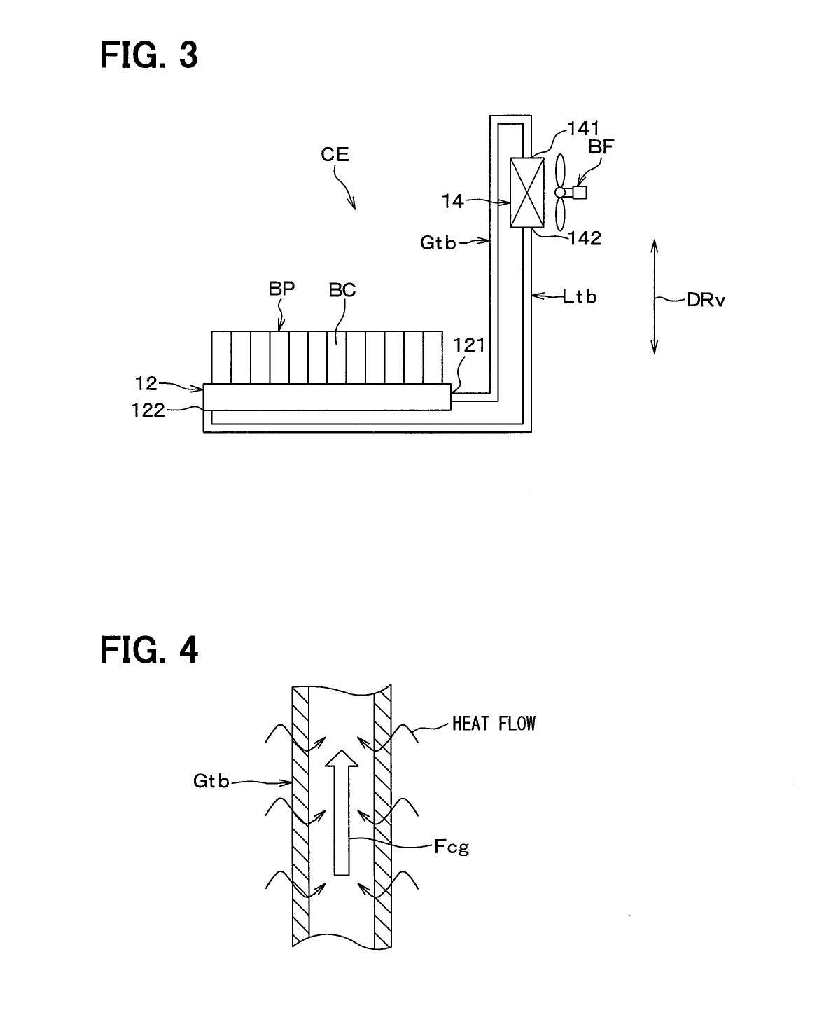

FIG. 3 is a schematic diagram of a temperature controller CE corresponding to a comparative example of the device temperature controller 1 of the present embodiment. The temperature controller CE of the comparative example shown in FIG. 3 differs from the device temperature controller 1 of present embodiment in that a gas passage portion Gtb and a liquid passage portion Ltb are separated from each other and exposed to the outside. For convenience of explanation, components of the temperature controller CE of the comparative example shown in FIGS. 3 to 5 and identical to the corresponding components of the device temperature controller 1 of the present embodiment are given identical reference numerals.

When the whole gas passage portion Gtb and the whole liquid passage portion Ltb are exposed to the outside as in the temperature controller CE of the comparative example as shown in FIG. 3, the gas passage portion Gtb and liquid passage portion Ltb receive heat from the outside.

Basically, gaseous working fluid flows through the gas passage portion Gtb. Accordingly, as shown in FIG. 4, the gas state of the working fluid is maintained at the gas passage portion Gtb even while receiving heat from the outside, wherefore the working fluid flows from the heat absorber 12 side toward the condenser 14 side.

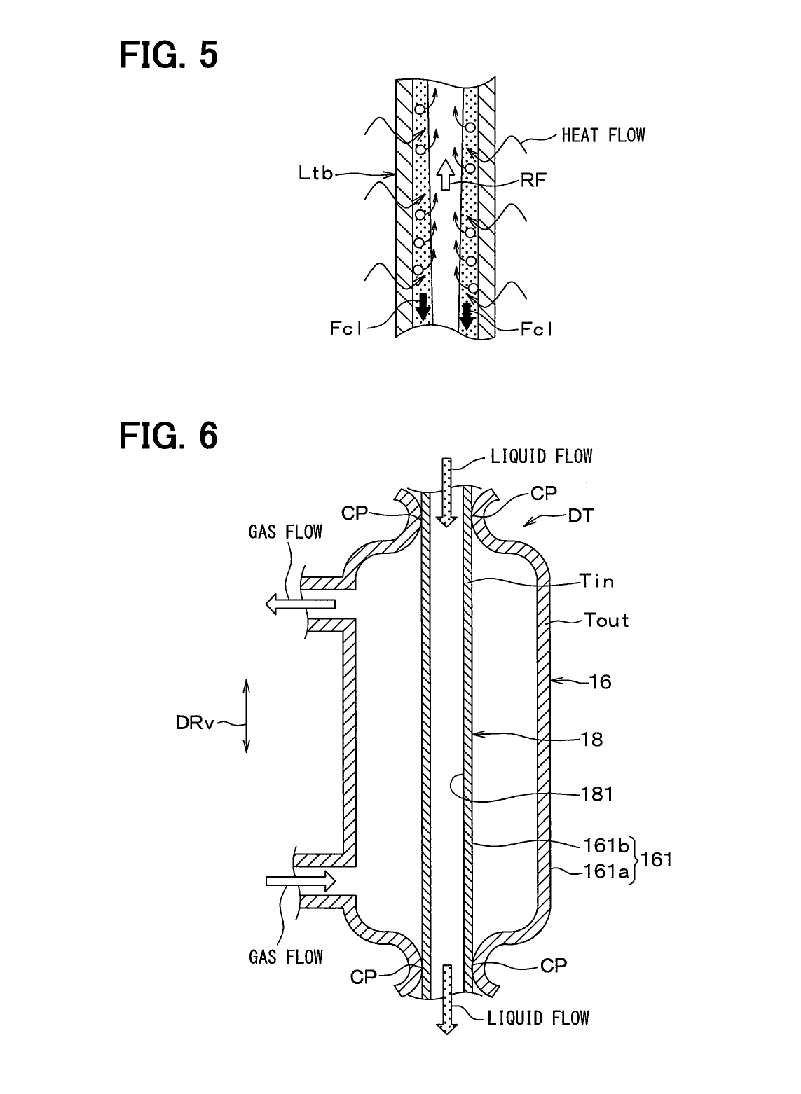

On the other hand, liquid working fluid basically flows through the liquid passage portion Ltb. Accordingly, the liquid working fluid present inside easily evaporates at the liquid passage portion Ltb by heat received from the outside as shown in FIG. 5.

When the liquid working fluid evaporates at the liquid passage portion Ltb, bubbles generated by evaporation of the working fluid flow backward from the heat absorber 12 side toward the condenser 14 side as indicated by an arrow RF in FIG. 5. This backflow of the bubbles is an undesirable factor which blocks circulation of the working fluid in the fluid circulation circuit 10, and lowers cooling performance of the heat absorbing unit 12 for the battery pack BP.

For example, one of solutions to this problem is to add a heat insulating member or the like to the outside or inside of the liquid passage portion Ltb to reduce heat reception from the outside by the working fluid flowing through the liquid passage portion Ltb. In this case, however, the configuration of the temperature controller CE becomes complicated, and the number of parts increases.

According to the device temperature controller 1 of the present embodiment, therefore, the gas passage portion 16 is brought into contact with a part of the liquid passage portion 18 to reduce heat reception from the outside at the liquid passage portion 18 as shown in FIGS. 1 and 2. Specifically, the liquid passage portion 18 of the present embodiment has a liquid side contact portion 181 in contact with the gas passage portion 16. In addition, the gas passage portion 16 of the present embodiment has a gas side contact portion 161 in contact with the liquid passage portion 18. In this configuration, only a part of the liquid passage portion 18 of present embodiment comes into contact with the gas passage portion 16, wherefore an area of a portion included in the liquid passage portion 18 and exposed to the outside is smaller than an area of an exposed portion of the liquid passage portion Ltb of the comparative example.

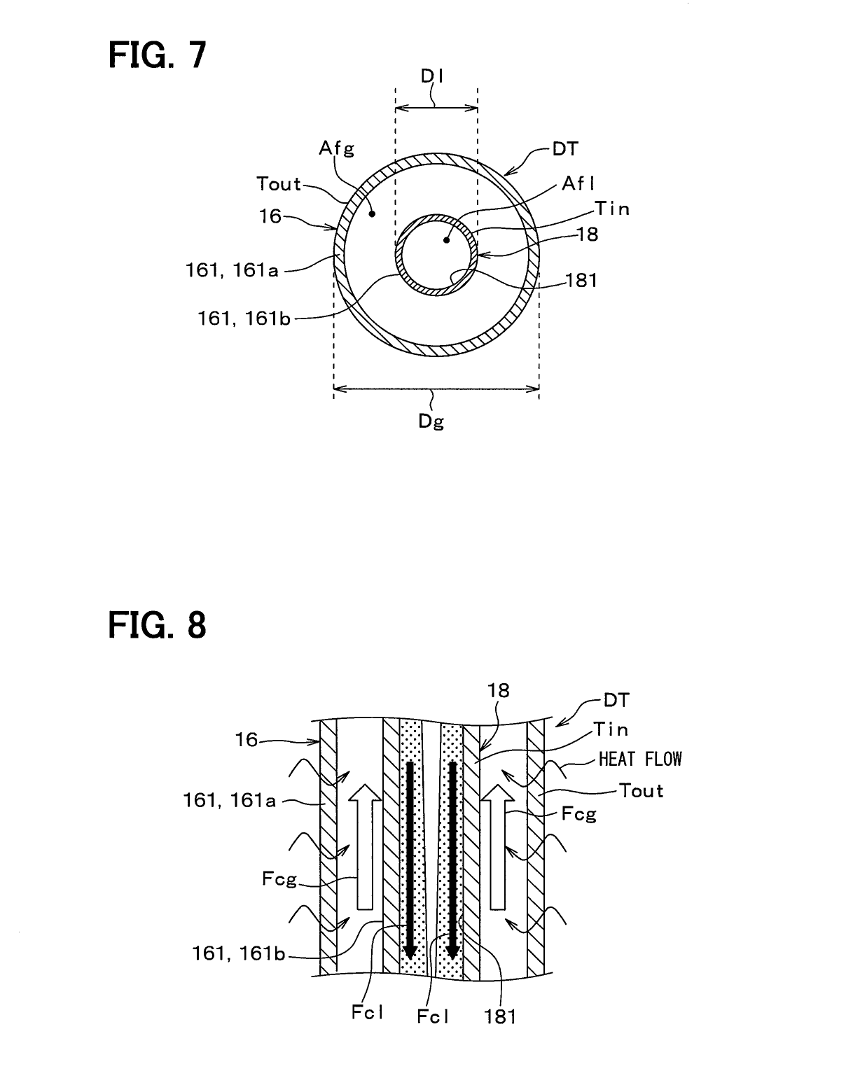

More specifically, as shown in FIGS. 6 and 7, the liquid passage portion 18 and the gas passage portion 16 of the present embodiment have a double pipe structure DT where the liquid passage portion 18 is located inside the gas passage portion 16 at intermediate portions of the respective passages. The liquid passage portion 18 and the gas passage portion 16 of the present embodiment are formed such that the gas passage portion 16 covers a side of the liquid passage portion 18 extending in the vertical direction DRv at the intermediate portions of the respective passages. According to the double pipe structure DT of the present embodiment, inlet and outlet of the liquid passage portion 18 are formed at upper end and lower end, respectively, while inlet and outlet of the gas passage portion 16 are formed on the side continuous with the upper end and lower end.

The liquid passage portion 18 and the gas passage portion 16 of present embodiment contact each other at least at a connecting portion CP between an inner pipe Tin and an outer pipe Tout of the double pipe structure DT. A part of each of the liquid passage portion 18 and the gas passage portion 16 includes the inner pipe Tin constituting the double pipe structure DT as a common part. It can be therefore interpreted that the liquid passage portion 16 and the gas passage portion 18 of present embodiment are configured such that the respective passage portions 16 and 18 contact each other via the inner pipe Tin of the double pipe structure DT.

According to the present embodiment, the portion included in the gas passage portion 16 and forming the double pipe structure DT constitutes the gas side contact portion 161 in contact with the liquid passage portion 18. More specifically, the gas side contact portion 161 includes a gas outer circumferential portion 161a constituted by the outer pipe Tout forming the double pipe structure DT, and a gas inner circumferential portion 161b constituted by an outer circumferential portion of the inner pipe Tin forming the double pipe structure DT. The gas inner circumferential portion 161b is a portion included in the gas side contact portion 161 and in direct contact with the liquid passage portion 18.

According to the present embodiment, a portion included in the liquid passage portion 18 and forming the double pipe structure DT described above constitutes a liquid side contact portion 181 in contact with the gas passage portion 16. The liquid side contact portion 181 is constituted by an inner circumferential portion of the inner pipe Tin constituting the double pipe structure DT. According to the present embodiment, the entire circumference of the liquid side contact portion 181 of the liquid passage portion 18 is covered with the gas side contact portion 161 of the gas passage portion 16.

The liquid side contact portion 181 of the liquid passage portion 18 of the present embodiment is located inside the gas side contact portion 161 of the gas passage portion 16. Accordingly, an open edge length Lfwl of the liquid side contact portion 181 is smaller than an open edge length Lfwg of the gas side contact portion 161.

The open edge length Lfw coincides with a perimeter of each of the passage portions 16 and 18 in the passage cross section (i.e., passage sectional length). When the diameter of the liquid side contact portion 181 is DI, the circumferential length of the liquid side contact portion 181 in the passage cross section is about “π×DI”. When the outer diameter of the gas side contact portion 161 is Dg, the circumferential length of the gas side contact portion 161 in the passage cross section is about “π×(DI+Dg)”. Accordingly, the open edge length Lfwl of the liquid side contact portion 181 is smaller than the open edge length Lfwg of the gas side contact portion 161.

A hydraulic diameter Deg of the gas side contact portion 161 of the present embodiment is larger than a hydraulic diameter Del of the liquid side contact portion 181. A hydraulic diameter De is an equivalent diameter obtained by replacing a representative length of a pipe with a diameter of a cylindrical pipe, and defined by following Formula F1.

De=4×Af/Lfw (F1)

In above formula F1, Af indicates a passage sectional area, while Lfw indicates an open edge length.

As described above, the open edge length Lfwl of the liquid side contact portion 181 of the present embodiment is smaller than the open edge length Lfwg of the gas side contact portion 161. According to the gas passage portion 16 of present embodiment, therefore, the gas side contact portion 161 has a passage sectional area Afg larger than a passage sectional area Afl of the liquid side contact portion 181 to obtain the larger hydraulic diameter Deg of the gas side contact portion 161 than the hydraulic diameter Del of the liquid side contact portion 181.

The control device 100 constituting an electronic controller of the device temperature controller 1 will now be described with reference to FIG. 1. The control device 100 shown in FIG. 1 is constituted by a microcomputer including a processor and a storage unit (e.g., read-only memory (ROM) and random-access memory (RAM)), and peripheral circuits of the microcomputer. The storage unit of the control device 100 is constituted by a non-transitory tangible storage medium.

The control device 100 performs various calculations and processes under a control program stored in the storage unit. The control device 100 controls operations of various devices such as the blowing fan BF connected to the output side of the control device 100.

Various sensor groups including a battery temperature detection unit 101 and a condenser temperature detection unit 102 are connected to the input side of the control device 100.

The battery temperature detection unit 101 is constituted by a temperature sensor which detects the battery temperature Tb of the battery pack BP. The battery temperature detection unit 101 may be constituted by a plurality of temperature sensors. In this case, the battery temperature detection unit 101 may be configured to calculate an average of detection values acquired by the plurality of temperature sensors, and outputs the average to the control device 100, for example.

The condenser temperature detection unit 102 is constituted by a temperature sensor which detects a temperature of working fluid present inside the condenser 14. The condenser temperature detection unit 102 is not required to have a configuration which directly detects the temperature of the working fluid present inside the condenser 14, but may have a configuration which detects a surface temperature of the condenser 14 as the temperature of the working fluid present inside the condenser 14, for example.

The control device 100 of the present embodiment is a device which integrates a plurality of control units constituted by hardware and software which control various control devices connected to the output side of the control device 100. The control device 100 of the present embodiment integrates a fan control unit 100a and the like for controlling a rotation speed of the blowing fan BF. When the temperature of the battery pack BP rises to a predetermined reference temperature, the control device 100 of present embodiment operates the blowing fan BF to promote heat release from the working fluid present at the condenser 14.

An operation of the device temperature controller 1 of the present embodiment will now be described. When the temperature of the battery pack BP rises to a predetermined reference temperature by self-heating or the like during traveling of the vehicle, the control device 100 of the device temperature controller 1 operates the blowing fan BF.

When the battery temperature Tb of the battery pack BP rises, heat of the battery pack BP transfers to the heat absorber 12 of the device temperature controller 1. A part of the liquid working fluid is evaporated at the heat absorber 12 by heat absorbed from the battery pack BP. At this time, the battery pack BP is cooled by latent heat of evaporation of the working fluid present inside the heat absorber 12, whereby the temperature of the battery pack BP lowers.

The gaseous working fluid evaporated at the heat absorber 12 flows from the gas outlet 122 of the heat absorber 12 to the gas passage portion 16, and flows toward the condenser 14 via the gas passage portion 16 as indicated by an arrow Fcg in FIG. 2.

The gaseous working fluid is condensed at the condenser 14 by heat release to blown air fed from the blowing fan BF. The gaseous working fluid liquefies inside the condenser 14, wherefore a specific gravity of the working fluid increases. As a result, the liquified working fluid inside the condenser 14 flows downward toward the liquid outlet 142 of the condenser 14 by the own weight of the working fluid.

The liquid working fluid condensed at the condenser 14 flows from the liquid outlet 142 of the condenser 14 to the liquid passage portion 18, and moves toward the heat absorber 12 via the liquid passage portion 18 as indicated by an arrow Fcl in FIG. 2.

As described above, in the device temperature controller 1, when the battery temperature Tb of the battery pack BP rises, the working fluid circulates between the heat absorber 12 and the condenser 14 while changing in phase between the gas state and the liquid state. In this manner, heat is transferred from the heat absorber 12 to the condenser 14 to cool the battery pack BP.

As shown in FIG. 7, a part of the liquid passage portion 18 of the present embodiment is covered with the gas passage portion 16. According to the device temperature controller 1 of the present embodiment, evaporation of the working fluid inside the liquid passage portion 18 by heat received from the outside can be reduced.

When the liquid passage portion 18 and the gas passage portion 16 contact each other as in present embodiment, there is a possibility that heat of the working fluid present inside the liquid passage portion 18 shifts to the working fluid present inside the gas passage portion 16.

However, in case of the device temperature controller 1 of the thermosiphon system, a temperature difference between the working fluid present inside the liquid passage portion 18 and the working fluid present inside the gas passage portion 16 is small. Accordingly, in case of the device temperature controller 1 of the thermosiphon system, substantially no heat exchange is caused between the working fluid present inside the liquid passage portion 18 and the working fluid present inside the gas passage portion 16.

The reason why the temperature difference between the working fluid inside the liquid passage portion 18 and the working fluid inside the gas passage portion 16 is small in the device temperature controller 1 of the thermosiphon system will be hereinafter described with reference to FIG. 8.

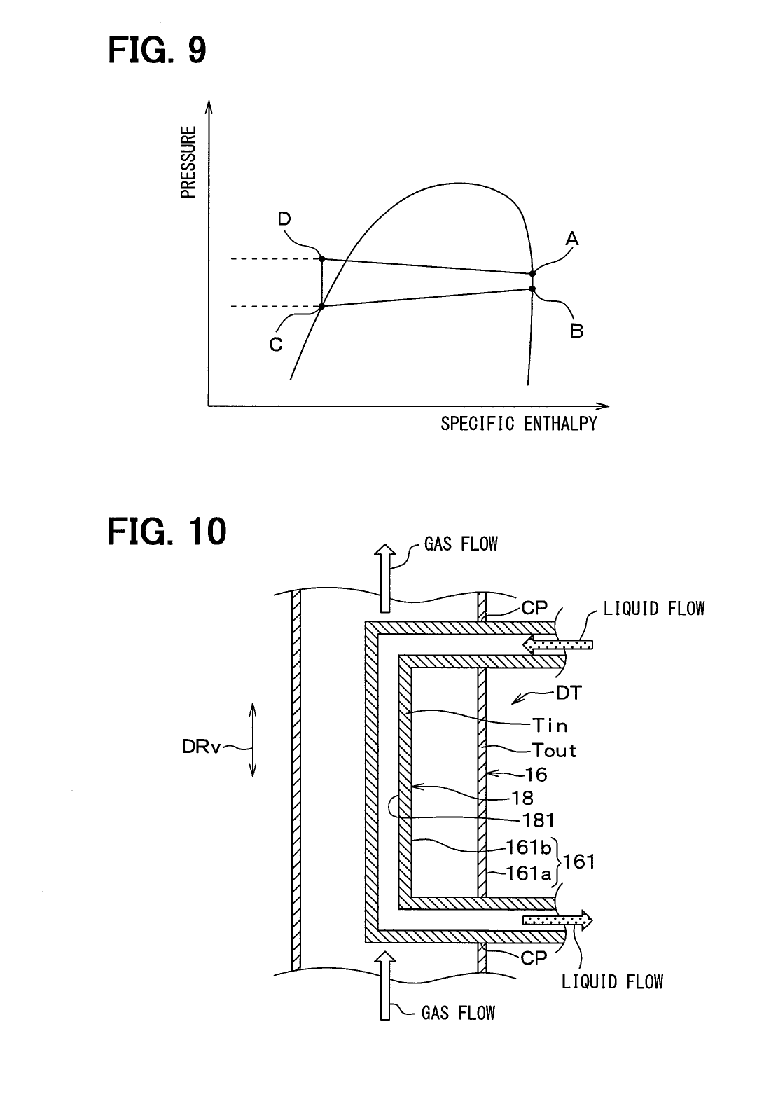

FIG. 9 is a Mollier diagram showing states of working fluid circulating in the fluid circulation circuit 10. In FIG. 9, a point A indicates a state of working fluid at the gas outlet 121 of the heat absorber 12, while a point B indicates a state of working fluid at the gas inlet 141 of the condenser 14. In FIG. 9, a point C indicates a state of working fluid at the liquid outlet 142 of the condenser 14, while a point D indicates a state of working fluid at the liquid inlet 122 of the heat absorber 12. For convenience of explanation, FIG. 9 shows an exaggerated actual pressure change.

Working fluid at the heat absorber 12 absorbs heat from the battery pack BP and evaporates. As a result, a degree of superheat becomes substantially zero at the gas outlet 121 of the heat absorber 12 as indicated by the point A in FIG. 9. The working fluid flowing from the gas outlet 121 of the heat absorber 12 to the gas passage portion 16 flows into the condenser 14 via the gas passage portion 16. At this time, the pressure of the working fluid slightly drops from the point A in FIG. 9 to the point B in FIG. 9 by a pressure loss at the gas passage portion 16.

The gaseous working fluid entering from the gas inlet 141 is condensed at the condenser 14, whereby enthalpy of the working fluid drops from the point B in FIG. 9 to the point C in FIG. 9 in a process from the gas inlet 141 to the liquid outlet 142.

The working fluid condensed at the condenser 14 again flows into the heat absorber 12 via the liquid passage portion 18. At this time, the pressure of the working fluid rises from the point C in FIG. 9 to the point D in FIG. 9 by a head difference Δh between the liquid surface of the working fluid at the liquid passage portion 18 and the liquid surface of the working fluid at the gas passage portion 16. Accordingly, the temperature of the working fluid at the gas passage portion 18 becomes higher than the temperature of the working fluid at the liquid passage portion 18.

However, a pressure rise at the point D in FIG. 9 from the point C in FIG. 9 is smaller than 15 kPa, wherefore the temperature difference between the working fluid at the gas passage portion 18 and the working fluid at the liquid passage portion 18 is extremely small. Accordingly, in case of the device temperature controller 1 of the thermosiphon system, substantially no heat exchange is caused between the working fluid present inside the liquid passage portion 18 and the working fluid present inside the gas passage portion 16.

According to the device temperature controller 1 of the present embodiment described above, a part of the liquid passage portion 18 is in contact with the gas passage portion 16. According to this configuration, the area of the portion included in the liquid passage portion 18 and exposed to the outside decreases, wherefore evaporation of the working fluid caused at the liquid passage portion 18 by heat received from the outside decreases.

Accordingly, the device temperature controller 1 of the present embodiment reduces backflow of the gaseous working fluid at the liquid passage portion 18, thereby securing a circulation flow rate of the working fluid in the fluid circulation circuit 10, and improving cooling performance of the battery pack BP at the heat absorber 12.

Moreover, according to the device temperature controller 1 of the present embodiment, the gas passage portion 16, which does not easily exchange heat with the liquid passage portion 18, functions as a heat insulating element for insulating a part of the liquid passage portion 18. Accordingly, the device temperature controller 1 of the present embodiment is more simplified than a configuration including an additional dedicated heat insulating element. According to the present embodiment, therefore, cooling performance of the device temperature controller 1 for the battery pack BP can be improved by a simplified configuration.

More specifically, according to the device temperature controller 1 of the present embodiment, the gas passage portion 16 and the liquid passage portion 18 constitute the double pipe structure DT where at least a part of the liquid passage portion 18 is located inside the gas passage portion 16. According to the device temperature controller 1 of the present embodiment, the entire circumference of the liquid side contact portion 181 of the liquid passage portion 18 is covered with the gas side contact portion 161 of the gas passage portion 16. In this configuration, the liquid side contact portion 181 is not exposed to the outside in the state that the entire circumference of the liquid side contact portion 181 is covered with the gas side contact portion 161. This configuration can sufficiently reduce evaporation of the working fluid caused at the liquid passage portion 18 by heat received from the outside.

According to the device temperature controller 1 of the present embodiment, the open edge length of the liquid side contact portion 181 of the liquid passage portion 18 is smaller than the open edge length of the gas side contact portion 161 of the gas passage portion 16. This configuration can sufficiently reduce the area of the part included in the liquid side contact portion 181 and receiving heat from the outside, thereby sufficiently reducing evaporation of the working fluid caused at the liquid passage portion 18 by heat received from the outside.

According to the device temperature controller 1 of the present embodiment, the passage sectional area of the liquid side contact portion 181 of the liquid passage portion 18 is smaller than the passage sectional area of the gas side contact portion 161 of the gas passage portion 16. In this case, the liquid surface at the liquid passage portion 18 is located higher than the liquid surface at the gas passage portion 16, wherefore the circulation flow rate of the working fluid in the fluid circulation circuit 10 can be raised by the head difference between the liquid surface at the liquid passage portion 18 and the liquid surface at the gas passage portion 16. Accordingly, this configuration can improve cooling performance for the battery pack BP by securing a sufficient circulation flow rate of the working fluid in the fluid circulation circuit 10.

When the liquid passage portion 18 and the gas passage portion 16 have the same flow rate and the same hydraulic diameter, a larger pressure loss is produced at the gas passage portion 16 through which gaseous working fluid flows. The reason why a larger pressure loss is produced at the gas passage portion 16 than at the liquid passage portion 18 will be described below.

A larger pressure loss at the gas passage portion 16 is an undesirable factor which blocks circulation of the working fluid in the fluid circulation circuit 10 and lowers cooling performance for the battery pack BP at the heat absorber 12.

According to the device temperature controller 1 of the present embodiment, however, the hydraulic diameter Deg of the gas side contact portion 161 of the gas passage portion 16 is larger than the hydraulic diameter Del of the liquid side contact portion 181 of the liquid passage portion 18. This configuration can reduce the pressure loss at the gas passage portion 16, thereby securing a sufficient circulation flow rate of the working fluid in the fluid circulation circuit 10, and improving cooling performance for the battery pack BP.

The reason why a larger pressure loss is produced at the gas passage portion 16 than at the liquid passage portion 18 will be hereinafter described. Initially, according to a following formula of continuity (Formula F2 shown below), a value obtained by multiplying density ρ of working fluid flowing through the fluid circulation circuit 10 by a passage sectional area Af and a flow velocity v of the working fluid is constant.

ρ×Af×v=constant (F2)

Gaseous working fluid has lower density ρ than that of liquid working fluid. Accordingly, when the passage sectional area Af is constant, the flow velocity of the gaseous working fluid flowing through the gas passage portion 16 and having smaller density is higher than the flow velocity of the liquid working fluid flowing through the liquid passage portion 18.

In addition, a pressure loss (more specifically, friction loss) ΔP of a pipe is expressed by following formulas F3 and F4.

≢P=ζ×{(π×v2)/2} (F3)

ζ=λ×(|×De)∝λ×(|/Af½) (F4)

In formula F4, λ indicates a pipe friction coefficient, De indicates a hydraulic diameter, and | indicates a pipe length. The passage sectional area Af is proportional to the square of the hydraulic diameter De. Accordingly, ζ in formula F4 is proportional to the 0.5th power of the passage sectional area Af.

According to Formula F3, the pressure loss is proportional to the density ρ, and is proportional to the square of the flow velocity v. Accordingly, when the passage sectional area Af is constant, the gaseous working fluid having higher flow velocity than the flow velocity of the liquid working fluid produces a larger pressure loss.

### Modified Example of First Embodiment

According to the structure presented in the first embodiment described above, the inlet and outlet of the liquid passage portion 18 are formed at the upper end and lower end, respectively, and the inlet and outlet of the gas passage portion 16 are formed on the side between the upper end and lower end to constitute the double pipe structure DT. However, other structures may be adopted. For example, as shown in FIG. 10, the double pipe structure DT may have such a configuration which includes the inlet and outlet of the gas passage portion 16 formed at the upper end and lower end, respectively, and the inlet and outlet of the liquid passage portion 18 formed on the side continuous with the upper end and lower end, respectively.

### Second Embodiment

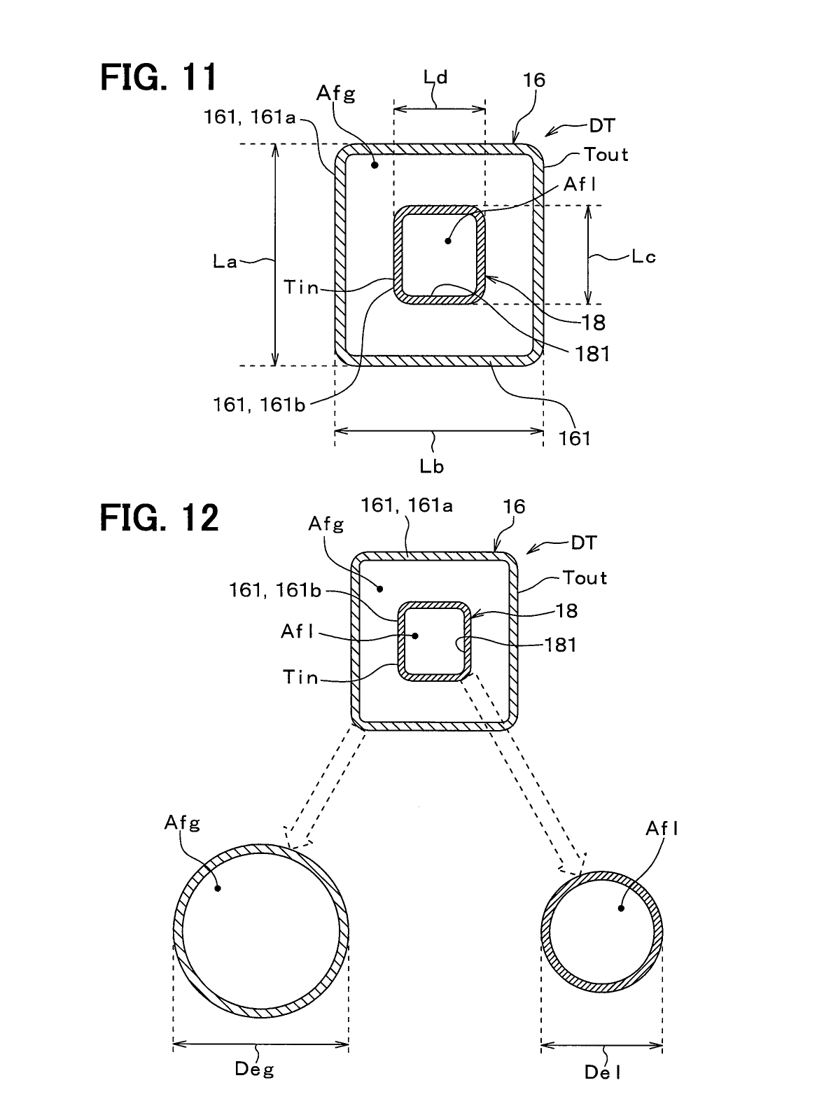

A second embodiment will be next described with reference to FIGS. 11 and 12. The device temperature controller 1 of the present embodiment is different from the device temperature controller 1 of the first embodiment in that the double pipe structure DT forming a part of the gas passage portion 16 and the liquid passage portion 18 is constituted by the outer pipe Tout and the inner pipe Tin each having a square pipe shape.

As shown in FIG. 11, a part of each of the liquid passage portion 18 and the gas passage portion 16 includes the inner pipe Tin constituting the double pipe structure DT as a common part. It can be therefore interpreted that the liquid passage portion 16 and the gas passage portion 18 of present embodiment are configured such that the respective passage portions 16 and 18 contact each other via the inner pipe Tin of the double pipe structure DT.

According to the present embodiment, the portion included in the gas passage portion 18 and forming the double pipe structure DT constitutes the gas side contact portion 161 in contact with the liquid passage portion 18. More specifically, the gas side contact portion 161 includes the gas outer circumferential portion 161a constituted by the outer pipe Tout having a square pipe shape and a square cross section, and the gas inner circumferential portion 161b constituted by an outer circumferential portion of the inner pipe Tin having a square pipe shape and a square cross section. The gas inner circumferential portion 161b is a portion included in the gas side contact portion 161 and in direct contact with the liquid passage portion 18.

According to the present embodiment, a portion included in the liquid passage portion 18 and forming the double pipe structure DT described above constitutes a liquid side contact portion 181 in contact with the gas passage portion 16. The liquid side contact portion 181 is constituted by an inner circumferential portion of the inner pipe Tin having a square pipe shape and a square cross section.

As described above, at least a part of the liquid passage portion 18 and the gas passage portion 16 of the present embodiment are constituted by the double pipe structure DT where the liquid passage portion 18 is located inside the gas passage portion 16. Specifically, the entire circumference of the liquid side contact portion 181 of the liquid passage portion 18 of the present embodiment is covered with the gas side contact portion 161 of the gas passage portion 16.

The liquid side contact portion 181 of the liquid passage portion 18 of the present embodiment is located inside the gas side contact portion 161 of the gas passage portion 16. Accordingly, the open edge length Lfwl of the liquid side contact portion 181 is smaller than the open edge length Lfwg of the gas side contact portion 161.

Assuming that a long side in the cross section of the liquid side contact part 181 is Lc, and that a short side in the cross section of the liquid side contact part 181 is Ld, a circumferential length of the passage cross section of the liquid side contact portion 181 Is about “2×Lc+2×Ld”.

Assuming that a long side on the outer circumferential side in the cross section of the gas side contact portion 161 is La, and that a short side in the cross section of the gas side contact portion 161 is Lb, a circumferential length in the passage cross section of the gas side contact portion 161 is about “2×(La+Lb+Lc+Ld)”. Accordingly, the open edge length Lfwl of the liquid side contact portion 181 is smaller than the open edge length Lfwg of the gas side contact portion 161.

As shown in FIG. 12, the hydraulic diameter Deg of the gas side contact portion 161 of the present embodiment is larger than the hydraulic diameter Del of the liquid side contact portion 181. As described above, the open edge length Lfwl of the liquid side contact portion 181 of the present embodiment is smaller than the open edge length Lfwg of the gas side contact portion 161. According to the gas passage portion 16 of present embodiment, therefore, the gas side contact portion 161 has a passage sectional area Afg larger than a passage sectional area Afl of the liquid side contact portion 181 to obtain the larger hydraulic diameter Deg of the gas side contact portion 161 than the hydraulic diameter Del of the liquid side contact portion 181.

Other configurations are similar to the corresponding configurations of the first embodiment. The device temperature controller 1 of the present embodiment produces operational effects similar to the operational effects of the device temperature controller 1 of the first embodiment by using configurations similar to the configurations of the first embodiment.

### Third Embodiment

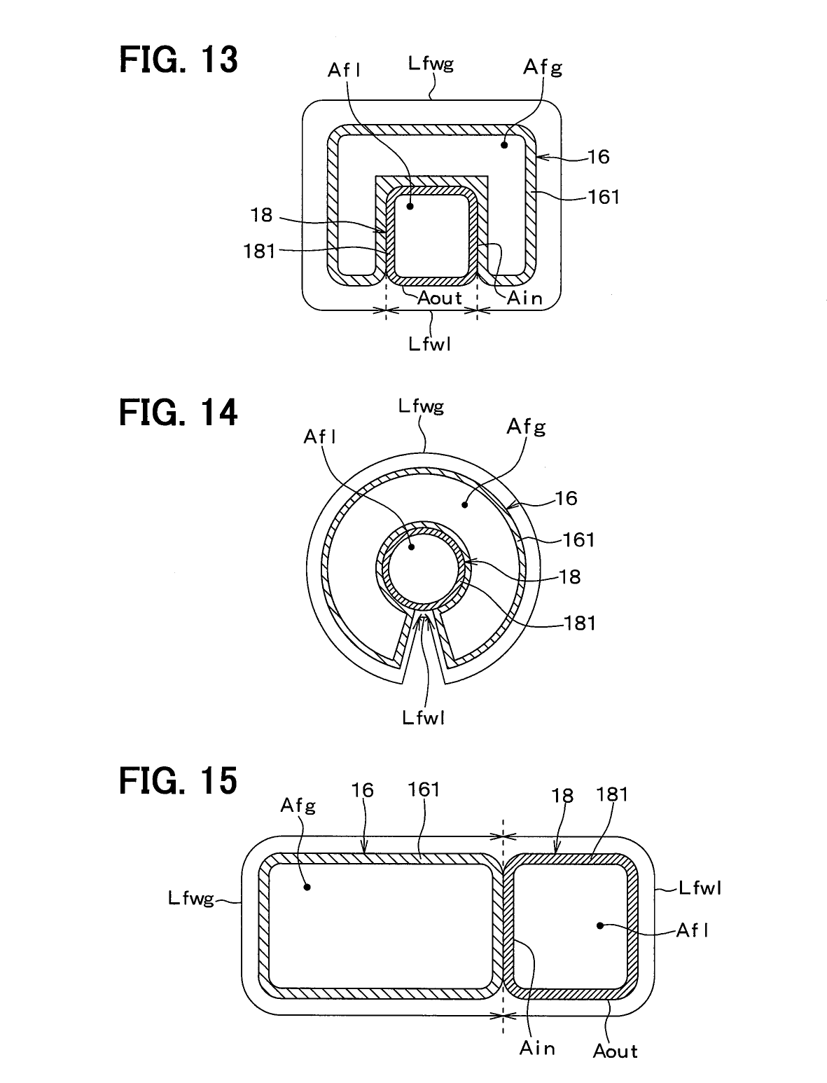

A third embodiment will be next described with reference to FIG. 13. The device temperature controller 1 of the present embodiment is different from the device temperature controller 1 of the first embodiment in that a part of the liquid side contact portion 181 of the liquid passage portion 18 is exposed to the outside.

As shown in FIG. 13, at least the gas side contact portion 161 of the gas passage portion 16 of the present embodiment is constituted by a pipe having a square pipe shape and a C-shaped cross section. At least the liquid side contact portion 181 of the liquid passage portion 18 of the present embodiment is constituted by a pipe having a square pipe shape and a square cross section.

More specifically, a part of the liquid side contact portion 181 of the liquid passage portion 18 of the present embodiment is covered with the gas side contact portion 161 of the gas passage portion 16. According to the present embodiment, the open edge length Lfwl of the portion included in the liquid side contact portion 181 of the liquid passage portion 18 and exposed to the outside is shorter than the open edge length Lfwg of the portion included in the gas side contact portion 161 of the gas passage portion 16 and exposed to the outside.

Most of the outer circumferential side portion of the liquid side contact portion 181 of the present embodiment contacts the gas side contact portion 161, wherefore an area Ain of the portion in contact with the gas side contact portion 161 is larger than an area Aout of the portion exposed to the outside.

Concerning the gas passage portion 16 of the present embodiment, the passage sectional area Afg of the gas side contact portion 161 is larger than the passage sectional area Afl of the liquid side contact portion 181 of the liquid passage portion 18, similarly to the first embodiment.

Other configurations are similar to the corresponding configurations of the first embodiment. The device temperature controller 1 of the present embodiment produces operational effects similar to the operational effects of the device temperature controller 1 of the first embodiment by using configurations similar to the configurations of the first embodiment.

According to the device temperature controller 1 of the present embodiment, a part of the liquid side contact portion 181 is exposed to the outside. The open edge length of the portion included in the liquid side contact portion 181 and exposed to the outside is smaller than the open edge length of the portion included in the gas side contact portion 161 and exposed to the outside. In this configuration, the area of the portion included in the liquid side contact portion 181 and receiving heat from the outside decreases, wherefore evaporation of the working fluid caused at the liquid passage portion 18 by heat received from the outside can be sufficiently reduced.

According to the device temperature controller 1 of the present embodiment, a part of the liquid side contact portion 181 is exposed to the outside. The area Ain of the portion included in the liquid side contact portion 181 and in contact with the gas side contact portion 161 is larger than the area Aout of the portion exposed to the outside. In this configuration, a most portion of at least a part of the liquid side contact portion 181 is covered with the gas side contact portion 161, and therefore hardly exposed to the outside. The device temperature controller 1 of the present embodiment therefore can sufficiently reduce evaporation of the working fluid caused at the liquid passage portion 18 by heat received from the outside.

### Modified Example of Third Embodiment

According to the third embodiment described above, the gas side contact portion 161 is constituted by a pipe having a square pipe shape and a C-shaped cross section, while the liquid side contact portion 181 is constituted by a pipe having a square pipe shape and a square cross section. However, other configurations may be adopted.

For example, as shown in FIG. 14, the device temperature controller 1 may include the gas side contact portion 161 constituted by a pipe having a tubular shape and a C-shaped cross section, and the liquid side contact portion 181 having a cylindrical shape.

### Fourth Embodiment

A fourth embodiment will be next described with reference to FIG. 15. The device temperature controller 1 of the present embodiment is different from the device temperature controller 1 of each of the above embodiments in that the area Ain of the portion included in the liquid side contact portion 181 and in contact with the gas side contact portion 161 is smaller than the area Aout of the portion exposed to the outside.

As shown in FIG. 15, at least the gas side contact portion 161 of the gas passage portion 16 of the present embodiment is constituted by a pipe having a square pipe shape and a square cross section. At least the liquid side contact portion 181 of the liquid passage portion 18 of the present embodiment is constituted by a pipe having a square pipe shape and a square cross section.

More specifically, according to the device temperature controller 1 of the present embodiment, the liquid side contact portion 181 of the liquid passage portion 18 and the gas side contact portion 161 of the gas passage portion 16 are arranged side by side such that each of the portions 181 and 161 comes into contact with each other via one surface. According to the present embodiment, the open edge length Lfwl of the portion included in the liquid side contact portion 181 of the liquid passage portion 18 and exposed to the outside is shorter than the open edge length Lfwg of the portion included in the gas side contact portion 161 of the gas passage portion 16 and exposed to the outside.

Concerning the gas passage portion 16 of the present embodiment, the passage sectional area Afg of the gas side contact portion 161 is larger than the passage sectional area Afl of the liquid side contact portion 181 of the liquid passage portion 18. According to the present embodiment, the area Ain of the portion included in the liquid side contact portion 181 and in contact with the gas side contact portion 161 is smaller than the area Aout of the portion exposed to the outside.

Other configurations are similar to the corresponding configurations of the first embodiment. The device temperature controller 1 of the present embodiment produces operational effects similar to the operational effects of the device temperature controller 1 of the first embodiment by using configurations similar to the configurations of the first embodiment.

According to the device temperature controller 1 of the present embodiment, a part of the liquid side contact portion 181 is exposed to the outside. The open edge length of the portion included in the liquid side contact portion 181 and exposed to the outside is smaller than the open edge length of the portion included in the gas side contact portion 161 and exposed to the outside. This configuration can sufficiently reduce the area of the part included in the liquid side contact portion 181 and receiving heat from the outside, thereby sufficiently reducing evaporation of the working fluid caused at the liquid passage portion 181 by heat received from the outside.

### Modified Example of Fourth Embodiment

According to the fourth embodiment described above, each of the gas side contact portion 161 and the liquid side contact portion 181 is constituted by a pipe having a square pipe shape and a square cross section. However, other configurations may be adopted.

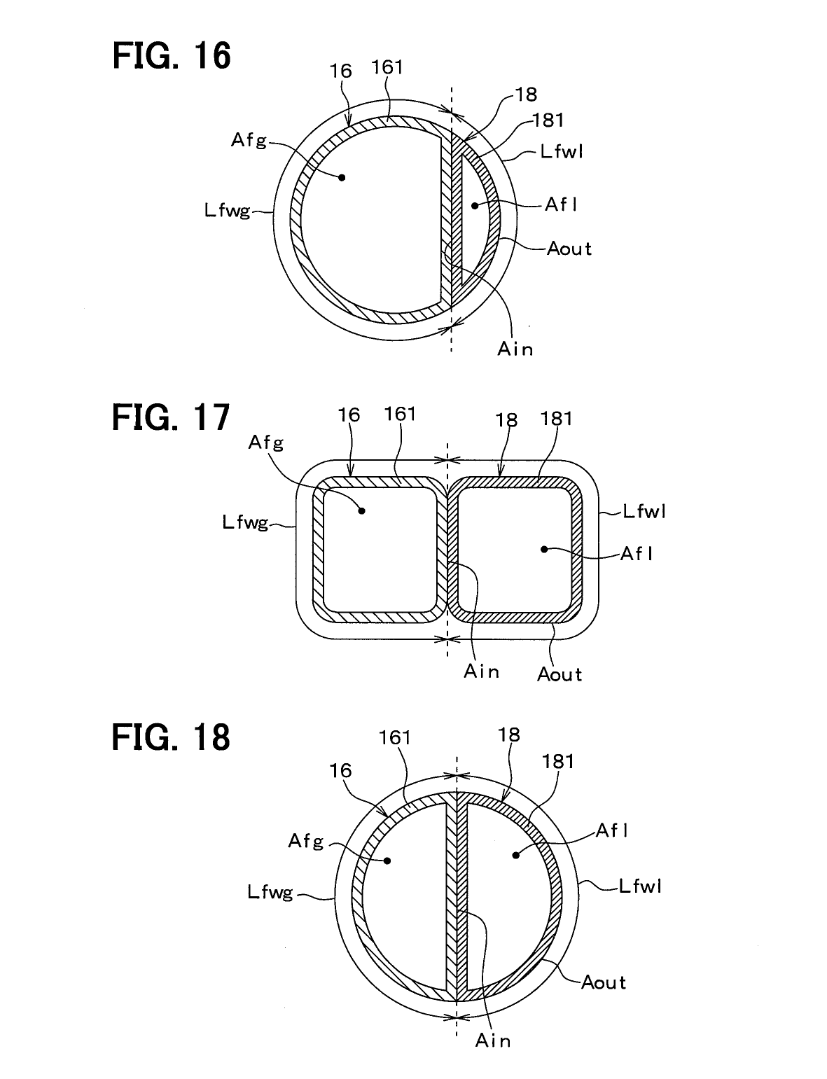

For example, as shown in FIG. 16, the cross section of each of the contact portions 161 and 181 of the device temperature controller 1 may be constituted by a pipe having a D-shaped cross section such that an entire cross section formed by the gas side contact portion 161 and a liquid side contact portion 181 becomes circular.

### Fifth Embodiment

A fifth embodiment will be next described with reference to FIG. 17. The device temperature controller 1 of the present embodiment is different from the device temperature controller 1 of each of the above embodiments in that the open edge length Lfwl of the part included in the liquid side contact portion 181 and exposed to the outside is equivalent to the open edge length Lfwg of the portion included in the gas side contact portion 161 and exposed to the outside.

As shown in FIG. 17, each of the gas side contact portion 161 and the liquid side contact portion 181 of the device temperature controller 1 of the present embodiment is constituted by a pipe having a square pipe shape and a square cross section. In addition, according to the device temperature controller 1 of the present embodiment, the liquid side contact portion 181 of the liquid passage portion 18 and the gas side contact portion 161 of the gas passage portion 16 are arranged side by side such that each of the portions 181 and 161 comes into contact with each other via one surface.

According to the present embodiment, the open edge length Lfwl of the portion included in the liquid side contact portion 181 and exposed to the outside is equivalent to the open edge length Lfwg of the portion included in the gas side contact portion 161 and exposed to the outside. Concerning the gas passage portion 16 of the present embodiment, the passage sectional area Afg of the gas side contact portion 161 is equivalent to the passage sectional area Afl of the liquid side contact portion 181 of the liquid passage portion 18.

Other configurations are similar to the corresponding configurations of the first embodiment. The device temperature controller 1 of the present embodiment produces operational effects similar to the operational effects of the device temperature controller 1 of the first embodiment by using configurations similar to the configurations of the first embodiment. For example, according to the device temperature controller 1 of the present embodiment, a part of the liquid passage portion 18 is configured to contact the gas passage portion 16. Accordingly, evaporation of the working fluid caused at the liquid passage portion 18 by heat received from the outside can be reduced.

### Modified Example of Fifth Embodiment

According to the fifth embodiment described above, each of the gas side contact portion 161 and the liquid side contact portion 181 is constituted by a pipe having a square pipe shape and a square cross section. However, other configurations may be adopted.

For example, as shown in FIG. 18, the cross section of each of the contact portions 161 and 181 of the device temperature controller 1 may be constituted by a pipe having a D-shaped cross section such that an entire cross section formed by the gas side contact portion 161 and a liquid side contact portion 182 becomes circular.

### Sixth Embodiment

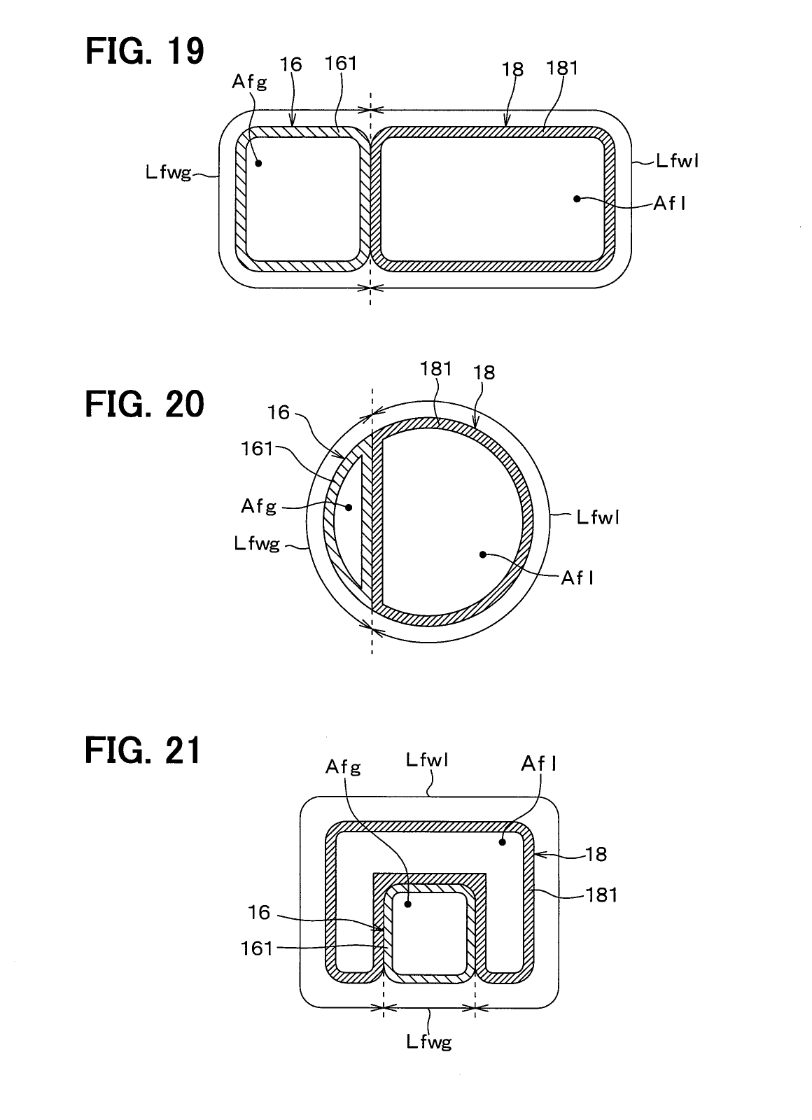

A sixth embodiment will be next described with reference to FIG. 19. The device temperature controller 1 of the present embodiment is different from the device temperature controller 1 of each of the above embodiments in that the open edge length Lfwl of the portion included in the liquid side contact portion 181 and exposed to the outside is larger than the open edge length Lfwg of the portion included in the gas side contact portion 161 and exposed to the outside.

As shown in FIG. 19, each of the gas side contact portion 161 and the liquid side contact portion 181 of the device temperature controller 1 of the present embodiment is constituted by a pipe having a square pipe shape and a square cross section. In addition, according to the device temperature controller 1 of the present embodiment, the liquid side contact portion 181 of the liquid passage portion 18 and the gas side contact portion 161 of the gas passage portion 16 are arranged side by side such that each of the portions 181 and 161 comes into contact with each other via one surface.

According to the present embodiment, the open edge length Lfwl of the portion included in the liquid side contact portion 181 and exposed to the outside is larger than the open edge length Lfwg of the portion included in the gas side contact portion 161 and exposed to the outside. Concerning the gas passage portion 16 of the present embodiment, the passage sectional area Afg of the gas side contact portion 161 is smaller than the passage sectional area Afl of the liquid side contact portion 181 of the liquid passage portion 18.

Other configurations are similar to the corresponding configurations of the first embodiment. The device temperature controller 1 of the present embodiment produces operational effects similar to the operational effects of the device temperature controller 1 of the first embodiment by using configurations similar to the configurations of the first embodiment. For example, according to the device temperature controller 1 of the present embodiment, a part of the liquid passage portion 18 is configured to contact the gas passage portion 16. Accordingly, evaporation of the working fluid caused at the liquid passage portion 18 by heat received from the outside can be reduced.

### Modified Examples of Sixth Embodiment

According to the sixth embodiment described above, each of the gas side contact portion 161 and the liquid side contact portion 181 is constituted by a pipe having a square pipe shape and a square cross section. However, other configurations may be adopted. The device temperature controller 1 according to first to third modified examples of the sixth embodiment will be hereinafter described with reference to FIGS. 20 to 22.

### First Modified Example

For example, as shown in FIG. 20, in the device temperature controller 1, each of the contact portions 161 and 181 of the device temperature controller 1 may be constituted by a pipe having a D-shaped cross section such that an entire cross section formed by the gas side contact portion 161 and a liquid side contact portion 182 becomes circular.

### Second Modified Example

For example, as shown in FIG. 21, the device temperature controller 1 may include the gas side contact portion 161 constituted by a pipe having a square pipe shape and a square cross section, and the liquid side contact portion 181 constituted by a pipe having a square pipe shape and a C-shaped cross section. In this manner, a part of the gas side contact portion 161 of the gas passage portion 16 in the device temperature controller 1 may be covered with the liquid side contact portion 181 of the liquid passage portion 18.

### Third Modified Example

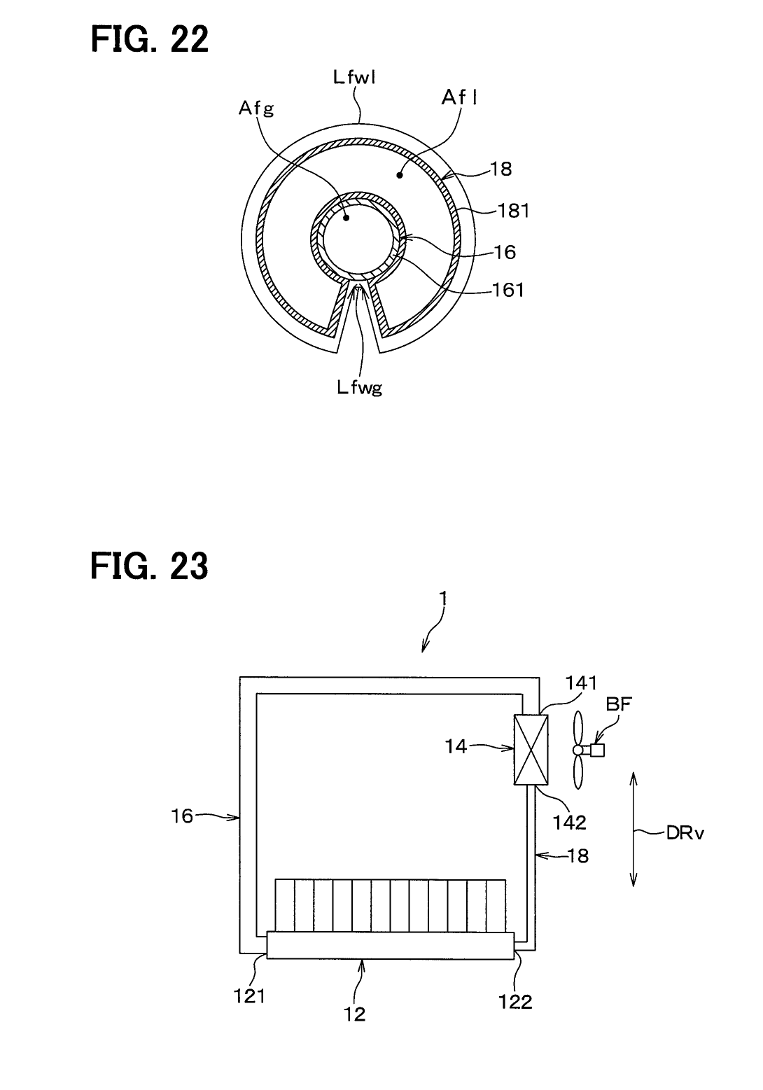

For example, as shown in FIG. 22, the device temperature controller 1 may include the liquid side contact portion 181 constituted by a pipe having a tubular shape and having a C-shaped cross section, and the gas side contact portion 161 constituted by a pipe having a cylindrical shape. In this manner, a part of the gas side contact portion 161 of the gas passage portion 16 in the device temperature controller 1 may be covered with the liquid side contact portion 181 of the liquid passage portion 18.

### Seventh Embodiment

A seventh embodiment will be next described with reference to FIGS. 23 to 25. The present embodiment is different from the first embodiment in that the gas passage portion 16 and the liquid passage portion 18 do not contact each other.

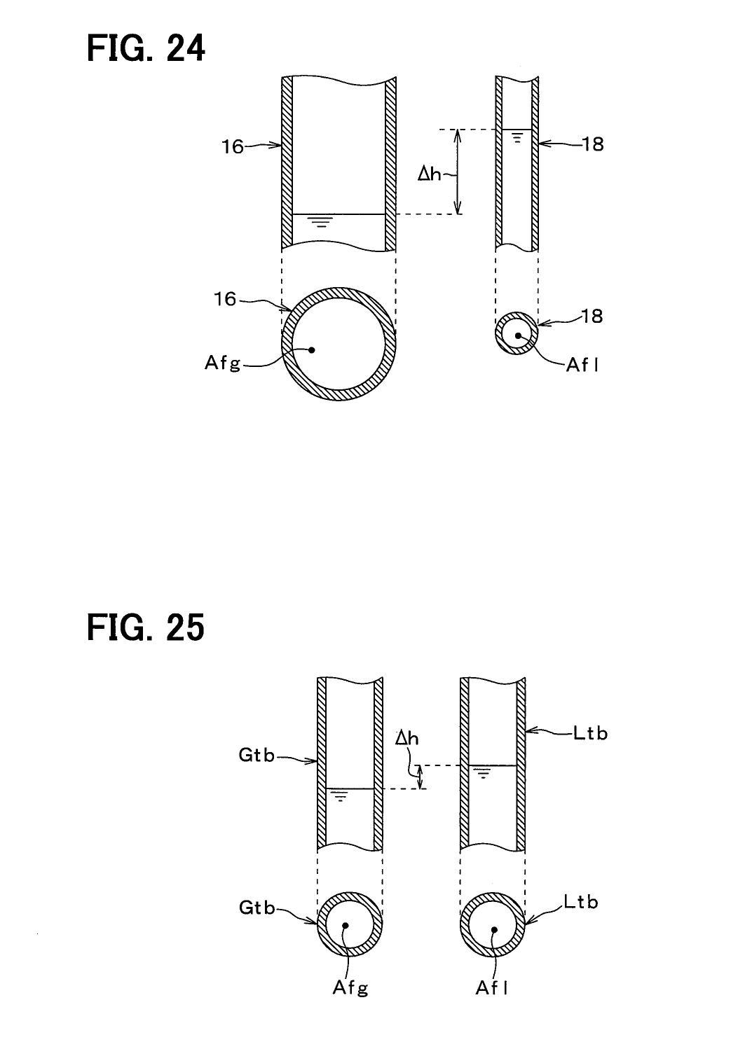

According to the device temperature controller 1 of the present embodiment, the gas passage portion 16 and the liquid passage portion 18 are separated from each other as shown in FIG. 23. In addition, as shown in FIG. 24, the passage sectional area Afl of at least a part of the liquid passage portion 18 of present embodiment is smaller than the passage sectional area Afg of the gas passage portion 16.

FIG. 25 is a cross-sectional view of the gas passage portion Gtb and the liquid passage portion Ltb of a temperature controller as a comparative example of the device temperature controller 1 of the present embodiment. The size of the passage sectional area Afl of the liquid passage portion Ltb in the comparative example shown in FIG. 25 is equal to the passage sectional area Afg of the gas passage portion Gtb.

When the passage sectional area Afl of the liquid passage portion Ltb is equal to the passage sectional area Afg of the gas passage portion Gtb as in this configuration, the difference between the liquid surface height of the gas passage portion Gtb and the liquid surface height of the liquid passage portion Ltb (i.e., head difference Δh) tends to decrease during cooling of the battery pack BP.

According to the device temperature controller 1 of the present embodiment, however, the passage sectional area Afl of the liquid passage portion 18 is smaller than the passage sectional area Afg of the gas passage portion 16. In this case, the liquid surface height of the liquid passage portion 18 is larger than the liquid surface height of the gas passage portion 16 not only during cooling of the battery pack BP, but also on other occasions. Accordingly, as shown in FIG. 24, the difference between the liquid surface height of the gas passage portion 16 and the liquid surface height of the liquid passage portion 18 (i.e., head difference Δh) during cooling of the battery pack BP increases more in the device temperature controller 1 of the present embodiment than that difference in the comparative example.

Other configurations are similar to the corresponding configurations of the first embodiment. According to the device temperature controller 1 of the present embodiment, the passage sectional area Afl of at least a part of the liquid passage portion 18 is smaller than the passage sectional area Afg of the gas passage portion 16.

According to this configuration, the liquid surface height at the liquid passage portion 18 tends to be larger than the liquid surface height at the gas passage portion 16 during cooling of the battery pack BP. In this case, the head difference Δh between the liquid surface height at the liquid passage portion 18 and the liquid surface height at the gas passage portion 16 can be easily secured. The device temperature controller 1 of the present embodiment therefore can raise the circulation flow rate of the working fluid in the fluid circulation circuit 10 during cooling of the battery pack BP. Accordingly, the device temperature controller 1 of the present embodiment can improve cooling performance for the battery pack BP by securing a sufficient circulation flow rate of the working fluid in the fluid circulation circuit 10.

Moreover, the device temperature controller 1 of the present embodiment can be implemented by changing the passage sectional area of at least one of the liquid passage portion 18 and the gas passage portion 16. In this case, the device temperature controller 1 does not become complicated, and the number of components does not increase. According to the present embodiment, therefore, cooling performance of the device temperature controller 1 for the battery pack BP can be improved by a simplified configuration.

According to the present embodiment described herein, each of the gas passage portion 16 and the liquid passage portion 18 is constituted by a cylindrical pipe. However, other configurations may be adopted. For example, each of the gas passage portion 16 and the liquid passage portion 18 may be constituted by a pipe having a square pipe shape and a square cross section.

### Other Embodiments

The present disclosure is not limited to the embodiments describe herein as representative examples, but may be modified in various manners as will be described in following examples.

In each of the embodiments described above, a fluorocarbon refrigerant is employed as working fluid. However, other refrigerants may be adopted. For example, working fluid may be other types of fluid such as propane and carbon dioxide.

In the first to sixth embodiments described above, a part of the gas passage portion 16 and a part of the liquid passage portion 18 contact each other. However, the entire gas passage portion 16 and the entire liquid passage portion 18 may be configured to contact each other.

In each of the embodiments described above, the condenser 12 is cooled by the blowing fan BF. However, other configurations may be adopted. For example, the condenser 14 may be cooled by cold heat generated in a vapor compression type refrigeration cycle, or may be cooled by an electronic cooler using a Peltier element or the like.

In each of the embodiments described above, the heat absorber 12 is disposed at a position facing the bottom surface portion of the battery pack BP. However, other configurations may be adopted. For example, the heat absorber 12 of the device temperature controller 1 may be disposed at a position facing the side surface portion of the battery pack BP.

In each of the embodiments described above, the device temperature controller 1 controls the temperature of the single battery pack BP. However, other configurations may be adopted. The device temperature controller 1 may control temperatures of a plurality of devices.

In each of the embodiments described above, the device temperature controller 1 of the present disclosure is applied to the device for controlling the battery temperature Tb of the battery pack BP mounted on the vehicle. However, other configurations may be adopted. Specifically, the device temperature controller 1 of the present disclosure is applicable not only to the battery pack BP, but also to a wide variety of devices for controlling temperatures of other devices, such as a motor, an inverter, and a charger mounted on a vehicle. In addition, the device temperature controller 1 is applicable not only to devices mounted on a vehicle, but also to devices requiring cooling at a base station or the like.

Needless to say, the elements constituting the embodiments described above are not necessarily essential unless clearly expressed as particularly essential, or considered as obviously essential in principle, for example.

Values such as numbers of the constituent elements, numerical values, quantities, and ranges in the embodiments described above are not limited to the specific values described herein unless clearly expressed as particularly essential, or considered as obviously limited to the specific values in principle, for example.

The shapes, positional relationships, or other conditions of the constituent elements and the like described in the embodiments are not limited to specific shapes, positional relationships, or other conditions unless clearly expressed, or limited to the specific shapes, positional relationships, or other conditions in principle.

### SUMMARY

According to a first aspect shown in a part or all of the embodiments described above, at least a part of the gas passage portion and at least a part of the liquid passage portion of the device temperature controller contact each other.

According to the configuration which brings a part of the liquid passage portion into contact with the gas passage portion, the area included in the liquid passage portion and exposed to the outside decreases. Accordingly, this configuration can reduce evaporation of the working fluid caused at the liquid passage portion by heat received from the outside.

This configuration therefore can reduce backflow of the gaseous working fluid flowing from the heat absorber side toward the condenser side via the liquid passage portion, thereby securing a circulation flow rate of the working fluid in the fluid circulation circuit, and improving cooling performance for the temperature control target device. The fluid circulation circuit is an annular circuit formed by connecting the heat absorber and the condenser via the gas passage portion and the liquid passage portion.

In addition, according to this configuration, the gas passage portion which does not easily exchange heat with the liquid passage portion functions as a heat insulating element for heat insulation of a part of the liquid passage portion. Accordingly, the device temperature controller can be more simplified than a configuration which additionally includes a dedicated heat insulation element. Accordingly, the device temperature controller having this configuration can improve cooling performance for the temperature control target device by a simplified configuration.

According to a second aspect shown in a part or all of the embodiments described above, at least a part of the gas passage portion and at least a part of the liquid passage portion of the device temperature controller constitute a double pipe structure where the liquid passage portion is located inside the gas passage portion.

In case of the double pipe structure where a part of the liquid passage portion is located inside the gas passage portion, the gas passage portion functions as a heat insulating element for insulating a part of the liquid passage portion. Accordingly, evaporation of the working fluid caused at the liquid passage portion by heat received from the outside can be sufficiently reduced. Furthermore, this configuration can achieve simplification of the device temperature controller more than a configuration which additionally includes a dedicated heat insulating element.

According to a third aspect, the device temperature controller is configured such that an open edge length of at least a part of the liquid side contact portion of the liquid passage portion is smaller than the open edge length of the gas side contact portion of the gas passage portion. This configuration can sufficiently reduce the area of the part included in the liquid side contact portion and receiving heat from the outside, thereby sufficiently reducing evaporation of the working fluid caused at the liquid passage portion by heat received from the outside.

According to a fourth aspect, the device temperature controller is configured such that a hydraulic diameter of at least a part of the gas side contact portion of the gas passage portion is larger than a hydraulic diameter of the liquid side contact portion of the liquid passage portion. This configuration can reduce the pressure loss at the gas passage portion, thereby improving cooling performance for the temperature control target device by securing a sufficient circulation flow rate of the working fluid in the fluid circulation circuit.

According to a fifth aspect, the device temperature controller is configured such that an entire circumference of at least a part of the liquid side contact portion of the liquid passage portion is covered with the gas side contact portion of the gas passage portion.

According to this configuration, the entire circumference of at least a part of the liquid side contact portion is covered by the gas side contact portion, and therefore configured not to be exposed to the outside. This configuration can sufficiently reduce evaporation of the working fluid caused at the liquid passage portion by heat received from the outside.

According to a sixth aspect, the device temperature controller is configured such that an open edge length of a portion exposed to the outside and included in at least a part of the liquid side contact portion of the liquid passage portion is smaller than an open edge length of a portion exposed to the outside and included in the gas side contact portion of the gas passage portion.

This configuration can sufficiently reduce the area of the part included in the liquid side contact portion and receiving heat from the outside, thereby sufficiently reducing evaporation of the working fluid caused at the liquid passage portion by heat received from the outside.

According to a seventh aspect, the device temperature controller is configured such that at least a part of the liquid side contact portion included in the liquid passage portion and in contact with the gas side contact portion included in the gas passage portion has a larger area than an area of a portion included in the liquid side contact portion and exposed to the outside.

In this configuration, a most portion of at least a part of the liquid side contact portion is covered with the gas side contact portion, and therefore hardly exposed to the outside. This configuration can sufficiently reduce evaporation of the working fluid caused at the liquid passage portion by heat received from the outside.

According to an eighth aspect shown in a part or all of the above-described embodiments, the device temperature controller is configured such that at least a part of the liquid passage portion has a passage sectional area smaller than a passage sectional area of the gas passage portion.

According to this configuration, the liquid surface at the liquid passage portion tends to be located higher than the liquid surface at the gas passage portion during cooling of the temperature control target device. In this case, a sufficient head difference between the liquid surface at the liquid passage portion and the liquid surface at the gas passage portion can be easily secured. The device temperature controller having this configuration therefore can raise the circulation flow rate of the working fluid in the fluid circulation circuit during cooling of the temperature control target device. Accordingly, this configuration can secure a sufficient circulation flow rate of the working fluid in the fluid circulation circuit, thereby improving cooling performance for the temperature control target device.

Moreover, the device temperature controller having this configuration can be implemented by changing the passage sectional area of at least one of the liquid passage portion and the gas passage. In this case, the device temperature controller does not become complicated, and the number of components does not increase. Accordingly, the device temperature controller having this configuration can improve cooling performance for the temperature control target device by a simplified configuration.

According to a ninth aspect, the temperature control target device of the device temperature controller is constituted by a battery pack mounted on a vehicle. This configuration can reduce excessive lowering of the battery temperature of the battery pack. Accordingly, deterioration of output characteristics caused by decrease in a chemical change inside the battery pack, and deterioration of input characteristics caused by increase in internal resistance of the battery pack are avoidable.

What is claimed is:

1. A device temperature controller configured to control a temperature of at least one temperature control target device, the device temperature controller comprising:
a heat absorber that absorbs heat from the temperature control target device to evaporate working fluid in liquid phase;
a condenser disposed above the heat absorber to condense the working fluid which has been evaporated into gas phase at the heat absorber;
a gas passage portion that guides the working fluid which has been evaporated into gas phase at the heat absorber to the condenser; and
a liquid passage portion that guides the working fluid which has been condensed into liquid phase at the condenser to the heat absorber, wherein
the temperature control target device includes a battery pack mounted on a vehicle, and
at least a part of the gas passage portion and at least a part of the liquid passage portion are in contact with each other.

2. A device temperature controller configured to control a temperature of at least one temperature control target device, the device temperature controller comprising:
a heat absorber that absorbs heat from the temperature control target device to evaporate working fluid which is liquid;
a condenser disposed above the heat absorber to condense the working fluid which has been evaporated into gas at the heat absorber;
a gas passage portion that guides the working fluid which has been evaporated into gas at the heat absorber to the condenser; and
a liquid passage portion that guides the working fluid which has been condensed into liquid at the condenser to the heat absorber, wherein
the temperature control target device includes a battery pack mounted on a vehicle, and
at least a part of the gas passage portion and at least a part of the liquid passage portion constitute a double pipe structure in which the liquid passage portion is located inside the gas passage portion.

3. The device temperature controller according to claim 1, wherein
an open edge length of at least a part of a liquid side contact portion included in the liquid passage portion and in contact with the gas passage portion is smaller than an open edge length of a gas side contact portion included in the gas passage portion and in contact with the liquid passage portion.

4. The device temperature controller according to claim 1, wherein
a hydraulic diameter of at least a part of a gas side contact portion included in the gas passage portion and in contact with the liquid passage portion is larger than a hydraulic diameter of a liquid side contact portion included in the liquid passage portion and in contact with the gas passage portion.

5. The device temperature controller according to claim 1, wherein
at least a part of a liquid side contact portion included in the liquid passage portion and in contact with the gas passage portion is entirely covered with a gas side contact portion included in the gas passage portion and in contact with the liquid passage portion.

6. The device temperature controller according to claim 1, wherein
the liquid passage portion includes a liquid side contact portion in contact with the gas passage portion,
the liquid side contact portion includes an exposed portion exposed to an outside,
the gas passage portion includes a gas side contact portion in contact with the liquid passage portion,
the gas side contact portion includes an exposed portion exposed to the outside, and
an open edge length of the exposed portion of at least a part of the liquid side contact portion is smaller than an open edge length of the exposed portion of the gas side contact portion.

7. The device temperature controller according to claim 1, wherein
the liquid passage portion includes a liquid side contact portion in contact with the gas passage portion,
the liquid side contact portion includes
a contact portion in contact with a gas side contact portion of the gas passage portion in contact with the liquid passage portion, and
an exposed portion exposed to an outside, and
an area of the contact portion is larger than an area of the exposed portion at least in a part of the liquid side contact portion.

8. A device temperature controller configured to control a temperature of at least one temperature control target device, the device temperature controller comprising:
a heat absorber that absorbs heat from the temperature control target device to evaporate working fluid which is liquid;
a condenser disposed above the heat absorber to condense the working fluid which has been evaporated into gas at the heat absorber;
a gas passage portion that guides the working fluid which has been evaporated into gas at the heat absorber to the condenser; and
a liquid passage portion that guides the working fluid which has been condensed into liquid at the condenser to the heat absorber, wherein
the temperature control target device includes a battery pack mounted on a vehicle, and
a cross-sectional area of at least a part of the liquid passage portion is smaller than a passage cross-sectional area of the gas passage portion.
